(19) United States
(12) Patent Application Publication
(10) Pub. No.: US 2020/0094145 A1
(43) Pub. Date: Mar. 26, 2020

(54) METHODS AND SYSTEMS FOR RECORDING VIRTUAL AVATARS MAINTAINED WITHIN A SINGLE BROWSER WINDOW

(71) Applicant: Small Factory Innovations LLC, Monmouth Beach, NJ (US)

(72) Inventors: Christopher Dudick, Monmouth Beach, NJ (US); David Gonzalez, Newbury Park, CA (US); Erik Guilfoyle, Howell, NJ (US)

(21) Appl. No.: 16/695,690

(22) Filed: Nov. 26, 2019

Related U.S. Application Data
(63) Continuation of application No. PCT/US2018/039035, filed on Jun. 22, 2018.
(60) Provisional application No. 62/523,935, filed on Jun. 23, 2017.

(51) Int. Cl. A63F 13/67; A63F 13/537

(52) U.S. Cl. CPC A63F 13/67; A63F 13/537

(57) ABSTRACT

Methods and devices for recording virtual avatars for social skills training, comprising securely logging into a website, selecting a social skill from a predefined list of social skills, initiating a 3D application with a purpose of use based on the selected social skill, defining a source of a user input, assigning the source of the user input to a trainee, receiving the user input from the trainee, selecting a 3D avatar to represent the trainee during the social skills training, monitoring levels of the user input, visually representing fluctuations in the levels of the user input in the 3D avatar, wherein the 3D avatar is a virtual representation of the user.

### CROSS REFERENCE TO RELATED APPLICATIONS

This application is a continuation of International Application No. PCT/US2018/039035, filed Jun. 22, 2018, which claims the benefit of priority from U.S. provisional patent application No. 62/523,935, filed Jun. 23, 2017, the contents of which are herein incorporated by reference in their entirety.

### FIELD OF THE INVENTION

There is provided a method and system for recording virtual avatars maintained within a single browser window.

### BACKGROUND

Social skills refer to the interaction and communication between two or more people. This includes behaviors both verbal and nonverbal used to effectively communicate and interact. Those affected by social dysfunction are often diagnosed with other major disorders such as autism, schizophrenia and social anxiety disorder.

Social skills training helps to improve the social dysfunction of those involved. Generally this type of psychotherapy is performed in a one-on-one or group situation in a classroom-type environment. This environment often involves common everyday distractions that impede the rapid success of such treatment.

Assessment of social skills training often involves an evaluation of individual social skills topics and results in pen and paper logs. The results are then evaluated for the purpose of determining a level of success.

### SUMMARY

One embodiment of a system is provided for generating a video of content from that which is rendered within an HTML container of a website page. The content is rendered via a 3D virtual game environment consisting of a background scene and one or more avatars.

The avatars are virtual representations of users and can be moved about the environment via an input device or client controlled medium. The avatar's mouths are preferably opened and closed as a result of audio levels of input provided by one or more attached microphones to the device rendering the browser content or provided by a client controlled medium for the purpose of causing the avatars to appear as if they are talking.

In one embodiment, recording begins and concludes preferably upon explicit request via input received from the user interface. Upon conclusion, captured video and audio data is sent to the hosting server. The hosting server combines the media and makes it available as a video file. Raw captured input data from the users is also sent to the server and stored. This data can later be used to rerender the virtual scene in real time like a 3D recording.

In yet another embodiment, there is a method for recording virtual avatars for social skills training, the method comprising: securely logging into a website, selecting a social skill from a predefined list of social skills, initiating a 3D application with a purpose of use based on the selected social skill, defining a source of a user input, assigning the source of the user input to a trainee, receiving the user input from the trainee, selecting a 3D avatar to represent the trainee during the social skills training, monitoring levels of the user input, representing, visually, fluctuations in the levels of the user input in the 3D avatar, wherein the 3D avatar is a virtual representation of the user.

In another embodiment of the method, the source of the user input is a microphone.

In another embodiment of the method, the visual representation comprises making a mouth of the 3D avatar animate in line with the received user input to appear as if the 3D avatar is talking.

In another embodiment of the method, a gamepad device is associated with the 3D avatar, wherein the gamepad device affects the 3D avatar in the form of movement of the 3D avatar.

In another embodiment of the method, recording begins and concludes upon an explicit request from the user interface.

In another embodiment of the method, recorded video data of the 3D avatar and audio data from the input source are combined at a hosting server to produce a video file.

In another embodiment, there is a device for recording virtual avatars for social skills training, the device comprising: a computer comprising a browser window for securely logging into a website, an HTML container, comprised within the browser window, wherein video content is rendered, wherein a social skill from a predefined list of social skills is selected, wherein a 3D application with a purpose of use based on the selected social skill is initiated, wherein a source of a user input is defined, wherein the source of the user input to a trainee is assigned, wherein the user input from the trainee is received, wherein a 3D avatar to represent the trainee during the social skills training is selected, wherein levels of the user input are monitored, wherein fluctuations in the levels of the user input are visually represented in the 3D avatar, wherein the 3D avatar is a virtual representation of the user, wherein the 3D avatar is maintained within the HTML container of the browser window.

In another embodiment of the device, the source of the user input is a microphone.

In another embodiment of the device, the visual representation comprises making a mouth of the 3D avatar animate in line with the received user input to appear as if the 3D avatar is talking.

In another embodiment of the device, a gamepad device is associated with the 3D avatar, wherein the gamepad device affects the 3D avatar in the form of movement of the 3D avatar.

In another embodiment of the device, recording begins and concludes upon an explicit request from the user interface.

In another embodiment of the device, recorded video data of the 3D avatar and audio data from the input source are combined at a hosting server to produce a video file.

In yet another embodiment, there is a non-transitory computer-readable medium having stored thereon executable instructions that, when executed by a processor of a computer, control the computer to perform steps directed to recording virtual avatars for social skills training, the steps comprising: securely logging into a website, selecting a social skill from a predefined list of social skills, initiating a 3D application with a purpose of use based on the selected social skill, defining a source of a user input, assigning the source of the user input to a trainee, receiving the user input from the trainee, selecting a 3D avatar to represent the trainee during the social skills training, monitoring levels of the user input, representing, visually, fluctuations in the levels of the user input in the 3D avatar, wherein the 3D avatar is a virtual representation of the user.

In another embodiment of the non-transitory computer-readable medium, the source of the user input is a microphone.

In another embodiment of the non-transitory computer-readable medium, the visual representation comprises making a mouth of the 3D avatar animate in line with the received user input to appear as if the 3D avatar is talking.

In another embodiment of the non-transitory computer-readable medium, a gamepad device is associated with the 3D avatar, wherein the gamepad device affects the 3D avatar in the form of movement of the 3D avatar.

In another embodiment of the non-transitory computer-readable medium, recording begins and concludes upon an explicit request from the user interface.

In another embodiment of the non-transitory computer-readable medium, recorded video data of the 3D avatar and audio data from the input source are combined at a hosting server to produce a video file.

### BRIEF DESCRIPTION OF THE DRAWINGS

Embodiments of the present invention described herein are exemplary, and not restrictive. Embodiments will now be described, by way of examples, with references to the accompanying drawings, in which:

FIG. 1 outlines one embodiment of input methods for control and audio data supplied to the software running on a computer either directly or indirectly via a networked server/client relationship.

FIG. 2 is a view showing one embodiment of the resulting software displaying via a browser window.

FIG. 3 is a view of one embodiment of user represented avatars in a 3D environment wherein the content displayed can be recorded.

FIG. 4 is a view of one embodiment of an audio way that can be analyzed for various levels of volume.

FIG. 5 is a view of one embodiment of a user represented avatar affected by the analyzed audio input.

FIG. 6 is a view one embodiment showing the emotive state of the avatar.

FIG. 7 is a view of one embodiment of the avatar's movement.

FIG. 8 is a flowchart of one embodiment of how a user logins and reaches the 3D interactive portion.

FIG. 9 is a flowchart of one embodiment of acquiring permission to access a directly connected audio input device.

FIG. 10 is a flowchart of one embodiment of selecting and assigning a 3D avatar to a specific user and selecting and assigning their audio input device.

FIG. 11 is a flowchart of one embodiment of selecting the 3D scene in which the avatar interacts.

FIG. 12 is a flowchart of one embodiment of combining the capture media to produce a video.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

Embodiments of the described technology relate to improving the results of social skills training while presenting a more efficient and comparable set of results for determining success.

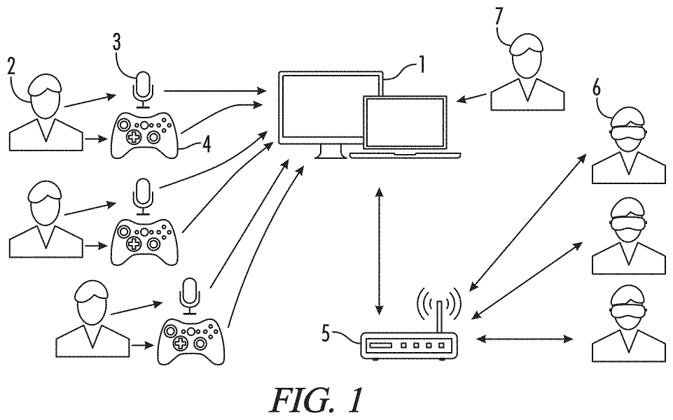

Turning to FIG. 1, microphone 3 and gamepad 4 are utilized by the user 2 as input devices for the computer 1 that is running the web application 5. The trainer 7 may oversee the use of the web application. Additional users 6 may also use the web application 5 in the networked server/client relationship.

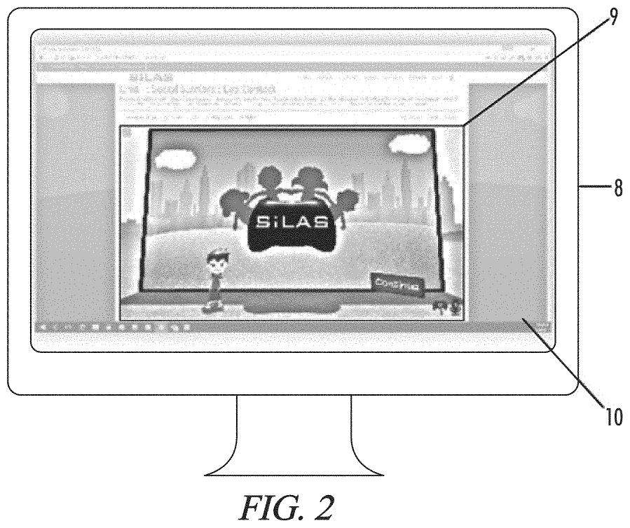

Turning now to FIG. 2, acquiring permission to access a directly connected audio input device is shown. The HTML container 9 of the web application 5 is displayed in a browser window 10 within a single computer 8.

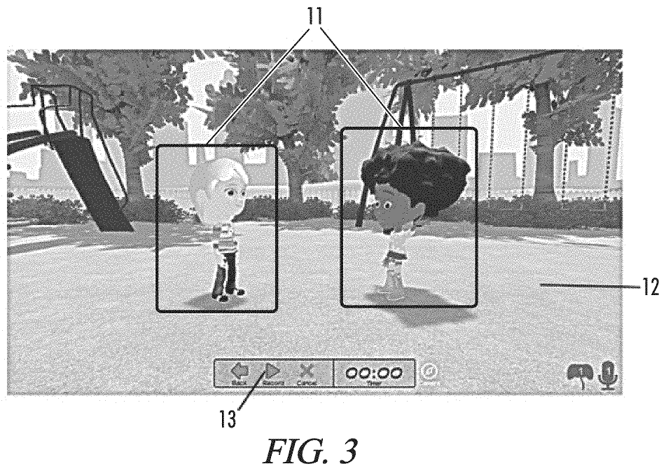

Turning now to FIG. 3, user represented avatars in a 3D environment are shown. In this 3D environment, the content displayed may be recorded. The avatars 11 can be seen in play in the 3D environment 12. The control panel 13 is at the bottom of the screen, where the user may go back, record, or cancel the present iteration. A timer is also displayed for time-keeping purposes. On the bottom right, there is a visual indication of which microphone 3 and gamepad 4 are currently being used.

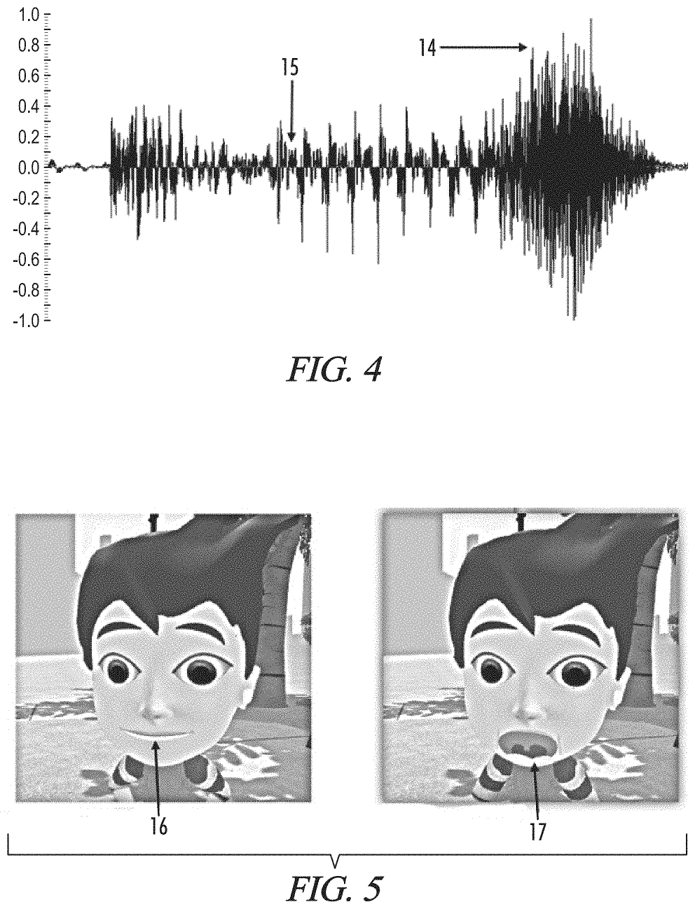

Turning now to FIG. 4, an audio wave that can be analyzed for various levels of volume is shown. Volume levels 14, 15 of the selected microphone 3 are particularly shown.

Turning now to FIG. 5, the mouth 16 of the avatar is animated 17 based on the audio input from the microphone 3. In this embodiment, the mouth may be closed or opened. In other embodiments, the entire face and body of the avatar may be animated to produce human emotions and reactions such as frowning, smiling, grinning, laughing, crying, etc.

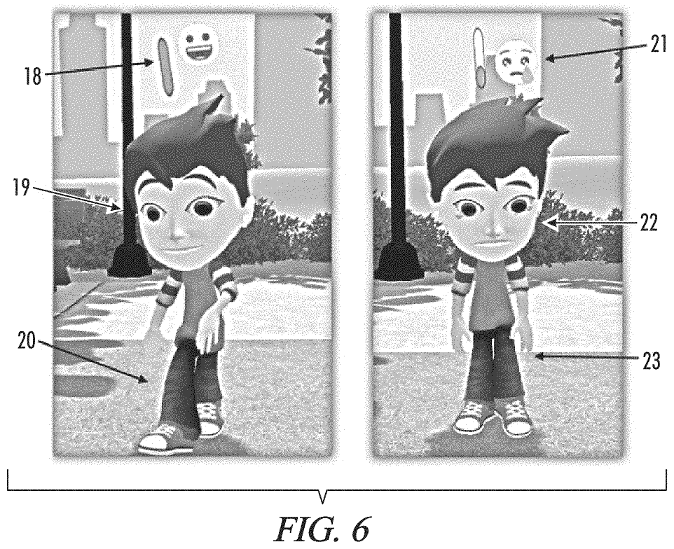

Turning now to FIG. 6, the emotive state of the avatar is shown. When the avatar is happy 18, it displays a happy face 19. The avatar may also be in a walking position 19. When the avatar is sad 21, it displays a sad face 22, which may include tears. The avatar may be in a standing position 23.

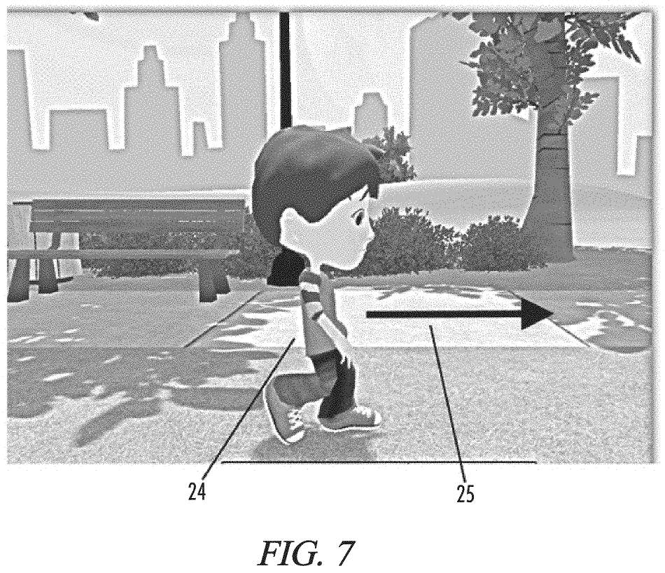

Turning now to FIG. 7, a moving avatar is shown. The movements 24, 25 of the avatar are shown. In this figure, the avatar is walking along a pathway looking forward with scenery in the background.

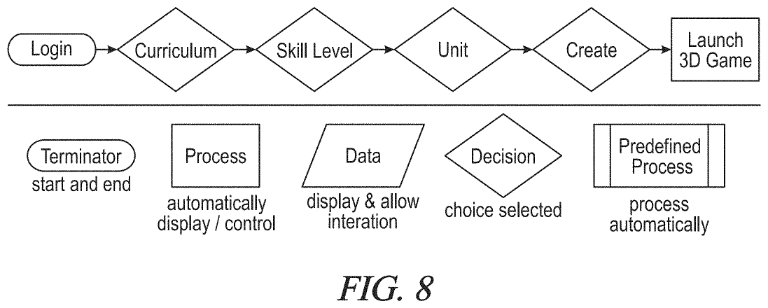

Turning now to FIG. 8, a flowchart of one embodiment of how a user logins and reaches the 3D interactive portion is shown. After login, the curriculum is chosen, the skill level is selected, and the unit is identified in order to launch the 3D game. The terminator determines the start and end of the game, the process automatically or manually displays and controls the program, the data allows for display and interaction, at each decision point a choice is selected, and a predefined process means the process takes place automatically.

In one embodiment, use of this technology begins by establishing parameters of use. In one embodiment, a trainer 7—be they a teacher, social worker or of other vocation—will securely log into the website that has implemented this technology. The trainer may login using a browser on their computer 1. (FIG. 8) In one embodiment, the trainer will select from an available list of predefined categories of social skills training. From these definitions, the technology will preferably have defined the primary user (trainer) and purpose of use. At this point, a 3D application embedded in the browser window will launch.

In the illustrated embodiment, input data from the additional users 2, 6 will allow for manipulation of visuals on screen 24, 25. In one embodiment, the application will then define the sources of input for the additional users as well as a 3D avatar that can be manipulated. Input data may be from, for example, a microphone 3, gamepad 4 or other controller 6 or input device as defined herein. Other input devices are contemplated.

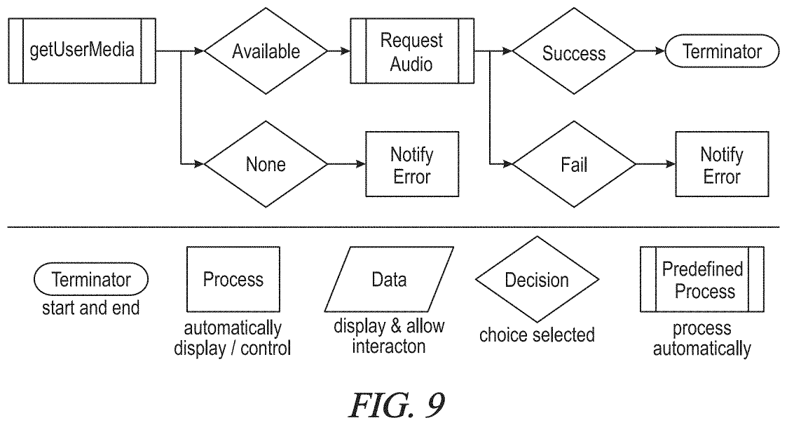

Turning now to FIG. 9, a flowchart of one embodiment of acquiring permission to access a directly connected audio input device is shown. When getUserMedia is initiated, a check is done to see if a media device, e.g. audio input device, is available. If the media device is not available, there is an error notification, e.g. “Notify Error.” If the media device is available, there is a request for audio. If the request fails, then there is an error notification. If the request is successful, then the process terminates.

In one embodiment, if the selected input is a directly connected microphone 3 and gamepad 4, the application will request permission from the trainer (FIG. 9) to access any available microphones actively available to the computer using a getUserMedia Javascript call in the browser. This permission will allow the application to see and access all available microphones.

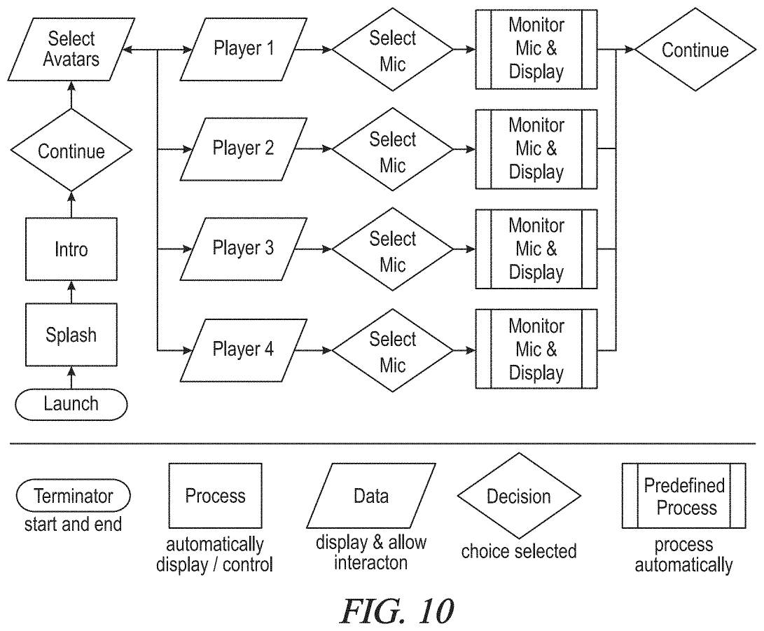

Turning now to FIG. 10, a flowchart of one embodiment of selecting and assigning a 3D avatar to a specific user and selecting and assigning their audio input device is shown. The program is launched, then comes the splash and introduction. Afterward, each player is linked to an avatar by manual or automatic selection. In this figure, up to four players may be selected, but 5, 6, 7 or more players may be selected in other embodiments. A microphone is then selected for each player. Each player's mic and display are monitored as the program continues to run.

In one embodiment, the trainer will select no less than one 3D avatar visually displayed in the browser and representing each trainee in the active session (FIG. 10). In another embodiment, the 3D avatar is automatically selected. In one embodiment, the trainer may assign an actively available microphone 3 to each trainee as was found by the browser when permission to do so was granted. Alternatively, an actively available microphone may be automatically assigned to each trainee. These may be the same, different or any combination of available microphones for each of the four avatars. Selecting a microphone indicates that the user will be providing input via a microphone and gamepad.

In one embodiment, the gamepad, including its buttons, that is assigned to this trainee could be defined at this point in the application either automatically or manually. The gamepad may also have one or more preset assignments or configurations.

In one embodiment, assigning the microphone will cause the application to begin actively monitoring the volume levels 14, 15 of the selected microphone (FIG. 10). These volume levels are then visually represented by making the mouths of the respective avatars animate 16, 17 in a way making them appear as if they are talking in line with the monitored input.

In one embodiment, if the selected input is a network connected device such as a VR/AR headset 6, the application will find networked devices actively engaged via a companion application. This companion application functioning on the networked device will communicate with the web application 5 providing information as to availability for use in the application for this trainer. This communication will preferably occur in a client-server relationship whereas the application's hosting computer acts as the server.

VR/AR headsets have the capability of providing input data via integrated microphones and motion controllers. Therefore one embodiment of this method of defining user data input could supersede that of other methods if selected as the source of data.

In one embodiment, a gamepad will not need to be assigned to this trainee as avatar input data will be provided by the networked device itself. Gamepad assignment is outlined later herein.

In one embodiment, the trainer will select no less than one 3D avatar visually displayed in the browser and representing each trainee in the active session. In one embodiment, the trainer will assign an actively available networked device as established previously to each trainee as was found available by the browser application. By selecting a networked device, the trainer is indicating that the user will be providing input via the networked device.

In one embodiment, assigning the networked device will cause the application to begin monitoring the volume levels 14, 15 of the audio provided by the networked device. These volume levels are then visually represented by making the mouths of the respective avatars animate 16, 17 in a way making them appear as if they are talking in line with the monitored input.

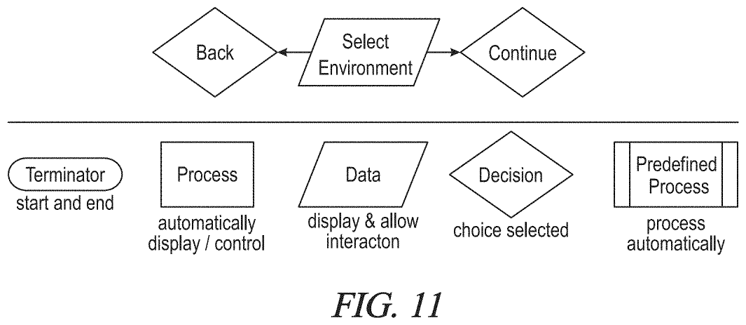

Turning now to FIG. 11, a flowchart of one embodiment of selecting the 3D scene in which the avatar interacts is shown. Here, the 3D scene environment is selected. After selection, the user may go back for reselection, go back to a previous portion of the program, or continue on.

In one embodiment, the trainer will continue within the application defining the environmental visuals (FIG. 11).

In one embodiment, if a microphone was previously selected as an input device instead of a networked device and when the trainer reaches the recording scene within the browser application, gamepad devices that are attached to the computer and recognized by the browser will have the ability to actively affect their represented avatar in the form of movement 24, 25. The first gamepad recognized by the browser will affect the first avatar. The second gamepad recognized by the browser will affect the second avatar. In such embodiment, this process will continue with each of the assigned avatars and connected gamepads. The trainer may also have the ability to re-assign each recognized gamepad button to any avatar.

In the embodiments described, there are at least three unique features established. The browser has recognized multiple directly connected microphones 3 and is capable of monitoring each of their inputs individually while displaying the resulting volume levels in the form of animated talking 16, 17 on the respective avatars. The browser has recognized multiple gamepads 4 and is capable of individually controlling the movements 24, 25 of the avatars. All of these features are occurring within a single browser window 10 from a single computer 8 simultaneously. Other features and benefits are contemplated within the scope of the present disclosure.

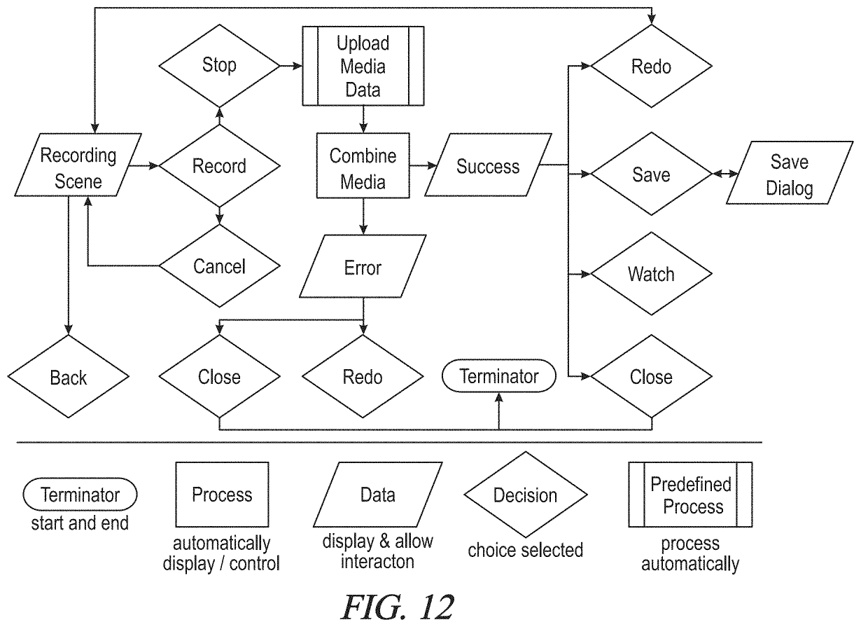

Turning now to FIG. 12, a flowchart of one embodiment of combining the capture media to produce a video is shown. When there is a scene in play (active/recording scene), the user may go back or decide to record. Upon recording, the user may cancel the recording or stop the recording. If the recording is stopped, all the media data is uploaded, then the 3D avatar video media is combined with the audio media. If there is an error in the media combination, the process is closed or another attempt is made at combining the media. If the media is successfully combined, the program may either go back to the active/recording scene, save the combined media and/or dialog, play the combined media, or close the process down.

In one embodiment, the trainer may continue within the application by choosing to record 13 the active scene as displayed within the 3D application embedded window (FIG. 12). Activating the recording function will cause the application to begin storing all monitored microphone input data as well as storing the visual output data as displayed in the 3D application window. This data will be temporarily stored in the browser memory.

In one embodiment, when the trainer stops the recording that was previously started, the stored audio data and stored video data along with some identifying information about the active session is sent to the website as POST data (FIG. 12). The website server receives the POST data and saves it to the server file system. In one embodiment, the website then initiates a compilation of the saved audio and video files with the intention of creating a single movie file. This compiled video is then made available to the trainer to download and/or view. The functions of the various elements shown in the figures can be provided through the use of dedicated hardware as well as hardware capable of executing software in association with appropriate software.

The present technology may allow for multiple input devices to be recognized by the browser to be captured, saved and utilized while also capturing the resulting visual output from a single browser window to later be combined into a single video file. Other features that may be incorporated in the present technology are as follows: simultaneously capture and save the audio data from multiple microphones; allow for multiple input devices (e.g. gamepads) to control content within a WebGL application; capture in video the visual data displayed from a WebGL application as presented in a browser window while also capturing audio data as described above; perform all capturing from within a single browser window; and combine the captured data and produce a video.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown.

The embodiments of the invention disclosed herein may comprise a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device may receive computer readable program instructions from the network and forward the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, Java, Perl, Python or the like, and conventional procedural programming languages, such as the “C” programming language or similar programming languages. The computer readable program instructions may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and/or computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A processor or processor circuity may include a device that has any combination of hardware, circuity, and software. The hardware and circuitry examples may comprise a parallel processor, a processor array, a vector processor, a scalar processor, a multi-processor, a microprocessor, a communication processor, a network processor, a logic circuit, a queue management device, a central processing unit (CPU), a microprocessing unit (MPU), system on a chip (SoC), a digital signal processor (DSP), an integrated circuit (IC), an application specific integrated circuit (ASIC), a programmable logic device (PLD), and a field programmable gate array (FPGA). A processor or processor circuity may include one or more processors, one or more circuits and software, that responds to and processes basic computer instructions and carries out the instructions of a computer program by performing the basic arithmetic, logical, control and input/output (I/O) operations specified by the instructions, one or more of: an arithmetic logic unit (ALU), which may carry out arithmetic and logic operations on the operands in instructions; a floating point unit (FPU), also known as a math coprocessor or numeric coprocessor, which is a specialized coprocessor that may manipulate numbers more quickly than the basic microprocessor circuitry can in some cases; one or more registers, which may hold instructions and other data and supply operands to the ALU and store the results of operations; and cache memory, which may save time compared to having to get data from random access memory (RAM). A processor or processor circuity may also include one or more circuits comprising electronic components, such as resistors, memristors, power sources, magnetic devices, motors, generators, solenoids, microphones, speakers, transistors, capacitors, inductors, diodes, semiconductors, switches, antennas, transducers, sensors, detectors, vacuums, tubes, amplifiers, radio receivers, crystals, and oscillators connected by conductive wires or traces through which electric current can flow. The combination of components and wires may allow various simple and complex operations to be performed: signals may be amplified, computations can be performed, and data can be moved from one place to another.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for recording virtual avatars for social skills training, the method comprising:
securely logging into a website,
selecting a social skill from a predefined list of social skills,
initiating a 3D application with a purpose of use based on the selected social skill,
defining a source of a user input,
assigning the source of the user input to a trainee,
receiving the user input from the trainee,
selecting a 3D avatar to represent the trainee during the social skills training,
monitoring levels of the user input,
representing, visually, fluctuations in the levels of the user input in the 3D avatar,
wherein the 3D avatar is a virtual representation of the user.

2. The method of claim 1, wherein the source of the user input is a microphone.

3. The method of claim 1, wherein the visual representation comprises making a mouth of the 3D avatar animate in line with the received user input to appear as if the 3D avatar is talking.

4. The method of claim 1, wherein a gamepad device is associated with the 3D avatar, wherein the gamepad device affects the 3D avatar in the form of movement of the 3D avatar.

5. The method of claim 1, wherein recording begins and concludes upon an explicit request from the user interface.

6. The method of claim 1, wherein recorded video data of the 3D avatar and audio data from the input source are combined at a hosting server to produce a video file.

7. A device for recording virtual avatars for social skills training, the device comprising:
a computer comprising a browser window for securely logging into a website,
an HTML container, comprised within the browser window, wherein video content is rendered,
wherein a social skill from a predefined list of social skills is selected,
wherein a 3D application with a purpose of use based on the selected social skill is initiated,
wherein a source of a user input is defined,
wherein the source of the user input to a trainee is assigned,
wherein the user input from the trainee is received,
wherein a 3D avatar to represent the trainee during the social skills training is selected,
wherein levels of the user input are monitored,
wherein fluctuations in the levels of the user input are visually represented in the 3D avatar,
wherein the 3D avatar is a virtual representation of the user,
wherein the 3D avatar is maintained within the HTML container of the browser window.

8. The device of claim 7, wherein the source of the user input is a microphone.

9. The device of claim 7, wherein the visual representation comprises making a mouth of the 3D avatar animate in line with the received user input to appear as if the 3D avatar is talking.

10. The device of claim 7, wherein a gamepad device is associated with the 3D avatar, wherein the gamepad device affects the 3D avatar in the form of movement of the 3D avatar.

11. The device of claim 7, wherein recording begins and concludes upon an explicit request from the user interface.

12. The device of claim 7, wherein recorded video data of the 3D avatar and audio data from the input source are combined at a hosting server to produce a video file.

13. A non-transitory computer-readable medium having stored thereon executable instructions that, when executed by a processor of a computer, control the computer to perform steps directed to recording virtual avatars for social skills training, the steps comprising:
securely logging into a website,
selecting a social skill from a predefined list of social skills,
initiating a 3D application with a purpose of use based on the selected social skill,
defining a source of a user input,
assigning the source of the user input to a trainee,
receiving the user input from the trainee,
selecting a 3D avatar to represent the trainee during the social skills training,
monitoring levels of the user input,
representing, visually, fluctuations in the levels of the user input in the 3D avatar,
wherein the 3D avatar is a virtual representation of the user.

14. The non-transitory computer-readable medium of claim 13, wherein the source of the user input is a microphone.

15. The non-transitory computer-readable medium of claim 13, wherein the visual representation comprises making a mouth of the 3D avatar animate in line with the received user input to appear as if the 3D avatar is talking.

16. The non-transitory computer-readable medium of claim 13, wherein a gamepad device is associated with the 3D avatar, wherein the gamepad device affects the 3D avatar in the form of movement of the 3D avatar.

17. The non-transitory computer-readable medium of claim 13, wherein recording begins and concludes upon an explicit request from the user interface.

18. The non-transitory computer-readable medium of claim 13, wherein recorded video data of the 3D avatar and audio data from the input source are combined at a hosting server to produce a video file.
